(19) United States
(12) Patent Application Publication
(10) Pub. No.: US 2012/0011038 A1
(43) Pub. Date: Jan. 12, 2012

(54) SYSTEM AND METHOD FOR GROSS PAYMENT ITEM DETERMINATION IN PROVIDING SOCIAL SERVICES

(75) Inventors: Mirko Schnack, Eppelheim (DE); Claus Steimer, Weingarten (DE); Miroslav Cina, Hanhofen (DE); Xiaopeng Tan, Mannheim (DE)

(73) Assignee: SAP AG, Walldorf (DE)

(21) Appl. No.: 12/833,427

(22) Filed: Jul. 9, 2010

(51) Int. Cl. G06Q 40/00; G06Q 10/00

(52) U.S. Cl. 705/35

(57) ABSTRACT

Disclosed are embodiments that provide a system, computer readable medium and a computer-implemented method for calculating gross payment items (GPIs) to provide monetary benefits to a recipient. The disclosed embodiment may use a computer processor of a back end of the computer system to generate an entitlement document for a benefit plan. The entitlement document may include a plurality of entitlement items, each including an entitlement amount for an entitlement period. The entitlement frequencies may be mapped to payment frequencies that each GPI has a corresponding entitlement item. Moreover, a due date for each GPI may be calculated and compared to a reference date to determine whether each GPI is due. Further, for each GPI, an existing overlapping GPI is checked and gross payment amounts are set by taking the existing overlapping GPI into account.

### REFERENCE TO RELATED APPLICATION

This Application incorporates by reference the entire contents of U.S. Non-Provisional application Ser. Nos. ______ (Atty Docket Nos. 11884/511301, 11884/511401, 11884/511501, 11884/511701, 11884/511801) filed ______, 2010.

### FIELD

The disclosed relates to a system and method for handling complex calculations related to providing proper monetary benefits. In particular, the disclosed relates to gross payment item determination for monetary benefits.

### BACKGROUND

Modern enterprises such as governmental organizations and private businesses typically use computer systems to manage their operations. Enterprise management systems are computerized systems that define processes and protocols for various business operations. By using enterprise management systems, public and private organizations can define processes that are to be undertaken during performance of the organization's operations which can be applied uniformly among a large set of employees.

In the case of public services providers, an enterprise management system can be used to manage provision of requested services. Conventional payroll applications such as SAP® Payroll solution are not designed for social services management. These payroll applications cannot be integrated naturally with social service functionalities that may require mass payment processing. Moreover, the social services plan may have an entitlement frequency different from the payment frequency. In order to insure accurate distribution of social services benefits, the enterprise business systems may update the status of beneficiaries, the status of applicable laws and regulations including tax changes, status changes resulting from legislation and other aspects of the provided social services that may be subject to change.

When these updates are implemented, the effects of the updates may be to the benefits received by a single person or the entire population of people receiving social services. It becomes very complicated and time consuming to not only identify those affected by the updates, but also perform individual changes to a person's or group of person's social services benefits. Both of these operations may be time consuming and may take a significant amount of time to process.

In addition, errors in the amounts of social service benefits provided may result in either a significant amount of either overpayment or underpayment of benefits which wastes resources and may adversely affect social service recipients. Accordingly, a need exists for a method and system for a gross payment determination that takes any existing payments into account, and for proper management of payments provided to the recipients.

### BRIEF DESCRIPTION OF THE DRAWINGS

FIG. 1 illustrates an exemplary document generation process according to an embodiment.

FIG. 2 illustrates an exemplary gross payment document according to an exemplary embodiment.

FIG. 3 illustrates an exemplary process flow according to an embodiment.

FIG. 4 illustrates an exemplary process flow for calculating gross payment amounts with an existing overlapping gross payment item (GPI) according to an embodiment.

FIG. 5 illustrates an exemplary computer system for implementing a social services system according to an embodiment.

### DETAILED DESCRIPTION

System and method for handling complex calculations in the management of monetary benefits are presented. In one embodiment, a computer-implemented method is provided for calculating gross payment items to provide monetary benefits to a recipient. The method may include using a computer processor of a back end of the computer system to generate an entitlement document for a benefit plan. The entitlement document may include data indicating the type of benefits to be provided by the benefit plan and a plurality of entitlement items. Each entitlement item may include an entitlement amount for an entitlement period. The method may further include mapping entitlement frequencies of the entitlement items to payment frequencies, and according to the mapped frequencies, generating a gross payment document containing a plurality of gross payment items (GPIs). Each generated gross payment item (GPI) may correspond to an entitlement item of the entitlement document. Moreover, the method may calculate due dates for the GPIs, determine whether each GPI being due by comparing the calculated due dates to a reference date; determine, for each gross payment item, whether there is existing overlapping GPI; and set gross payment amounts for each GPI by taking existing overlapping GPI into account.

Social services are commonly provided by governmental agencies in cooperation with service providing partners, such as private food pantries, soup kitchens, government-run health facilities, or private healthcare providers. The provision of social services, or simply benefits, is typically accomplished according to a social services plan developed for the requestor. For example, a requestor may be temporarily out of work and may need food stamps to feed his children and medical coverage for himself and his family, while another requestor may be homeless and need access to a shelter, clothing and food. Due to their circumstances, these two requestors may have differing status and, as a result, may require different plans for coordinating the benefits provided to each. The government social services office or department may formulate different social services plans for each of the requestors. Once the social services plan is developed (and approved), it may be implemented.

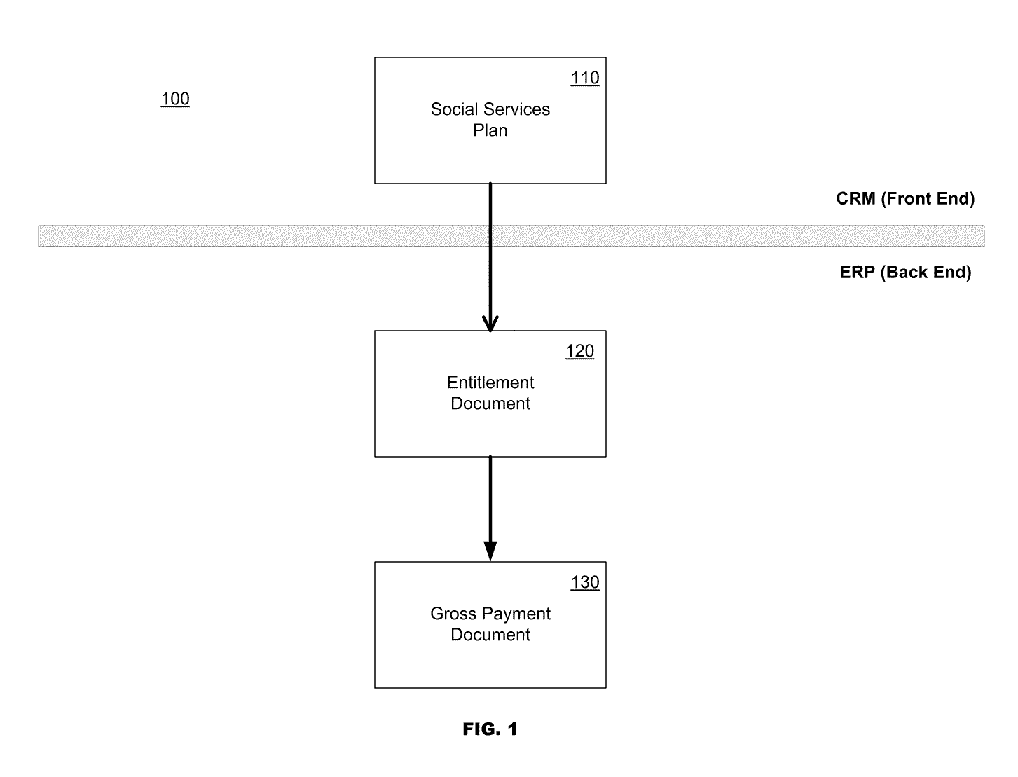

In order to manage the provision of the social services benefits, a number of electronic documents may be generated. The document generation flow after approval of a social services plan for a recipient will be described in more detail with reference to FIG. 1. FIG. 1 illustrates an exemplary document generation process according to an embodiment. For example, using a client computer at a front end of a computer system, a social services requestor/recipient may fill out an application requesting social service benefits, and begin the document generation process 100. Upon approval of the social services benefit request, a social services plan 110 may be created at the front end of the computer system. The social services plan 110 may be populated with data items. The data items in the social services plan 110 may include data such as, a unique identifier of the social services plan 110 or the requestor/recipient, the benefits to be provided (i.e., benefit scenario), identity of business partners that will be implementing the benefits scenario, the decision period (i.e., how long the benefits will last at the present levels), and header information. The unique identifier may be a case assignment number or some other indicator of the recipient related to the social services plan 110. The front end system such as a CRM system may release the data of the social services plan. The data is transferred from CRM to ERP using a remote function call. The remote function call may include, for example, the identity of the new social services plan 110 and the identity of programs for which the recipient has been approved. Upon release in the CRM, the back end ERP system may use the data of the social services plan 110 to generate entitlement data items of the entitlement items document comprising monetary amounts for the services indicated in the social services plan.

The generated entitlement document 120 may store the calculated monetary amounts of benefits for each of the social services identified in the social services plan 110 for the recipient. In addition to monetary amounts, the entitlement data items in the entitlement document 120 may also include data replicated from the social services plan 110 data items in the front end CRM application. The replicated data in the entitlement document 120 may include some or all of the data included in the social services plan 110. In addition, entitlement data items may be generated that include additional data, for example, a lifetime maximum benefit amount, related to entitlements for specific services.

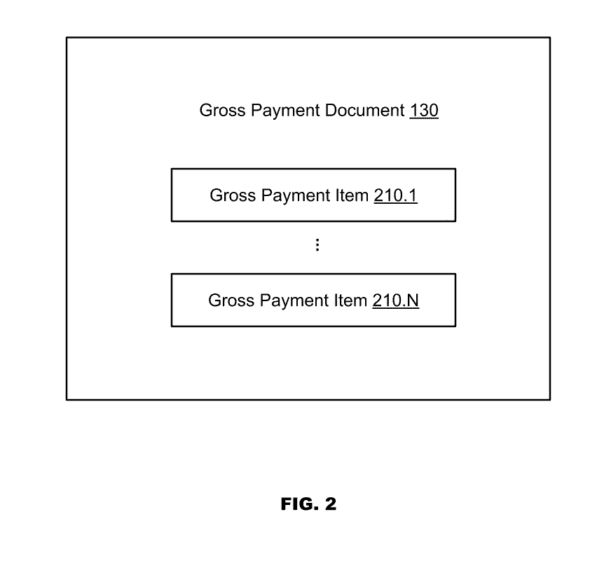

Specific service entitlements may include monetary values, for example, for a housing allowance, a food stamps allowance, a medical services allowance, a clothing allowance, and other monetary social service benefits allowances. The monetary value of specific service entitlements may be established according to current customizable rule sets as applied to the particular requestor's social services plan. Once the entitlement data items in the entitlement document 120 have been populated, the entitlement document 120 may be released. Upon release of the entitlement document, the front end CRM system may send data in the entitlement document 120 using, for example, a remote function call to the back end ERP system. The back end ERP system may calculate gross monetary payments that need to be paid to the recipient. The retrieved data may be incorporated into a gross payment document 130 by back end ERP system. In addition, results from the calculations of the gross monetary payments performed by back end ERP system may be stored as data items in the gross payment document 130. The entitled monetary values stored in the gross payment items may represent payment amounts prior to taxes, deductions and other factors that may reduce the payment. The content of the gross payment document 130 will be explained in more detail with reference to FIG. 2. It should be noted that although the exemplary embodiments are explained with a social services plan, the social services plan may represent any monetary benefit plans, such as, for example, pension plans run for retired military members, pension plans for private companies, insurance plans administered by an insurance company, payment plans administered by banks.

FIG. 2 illustrates a detailed example of the exemplary gross payment document 130 illustrated in FIG. 1. As shown in FIG. 2, the gross payment document 130 may comprise a plurality of gross payment items 210.1 to 210.N. N may be an integer number greater than one. In one embodiment, a gross payment item may be generated for a gross payment amount that is related to one entitlement item (ECR), one benefit, one benefit beneficiary, one payment recipient and one entitlement frequency period. Thus, N may represent number of frequency periods covered by a gross payment document and corresponding entitlement document. One gross payment item per entitlement frequency period may be a high granularity and may ensure a one to one relationship between gross payment items to entitlement items. This may be especially useful, because entitlement attributes may be unambiguously related to GPIs. In addition, later splits of GPIs during calculation may be prevented, because entitlement frequency periods are the smallest portion of time period. Further, older GPIs that have already been calculated but not yet paid out may be stopped for each GPI as a whole. For example, a gross payment item with a future due date (relative to a reference date to be described below) may be calculated for a payment period, and later a new gross payment item may be calculated to replace the older GPI. The existing gross payment item may be rendered obsolete and stopped. This may be referred to as “delimited.”

The gross payment document 130 may be part of the payment view on entitlements. For example, the gross payment document 130 may be created by adding payment information and by considering past payments. The gross payment amount contained in each gross payment item may be determined by a comparison between a current entitlement amount of an entitlement item against all already executed payment amounts for this entitlement item. In one embodiment, all previously existing gross payment items with a due date earlier than a reference date (to be described below) may be regarded as already executed.

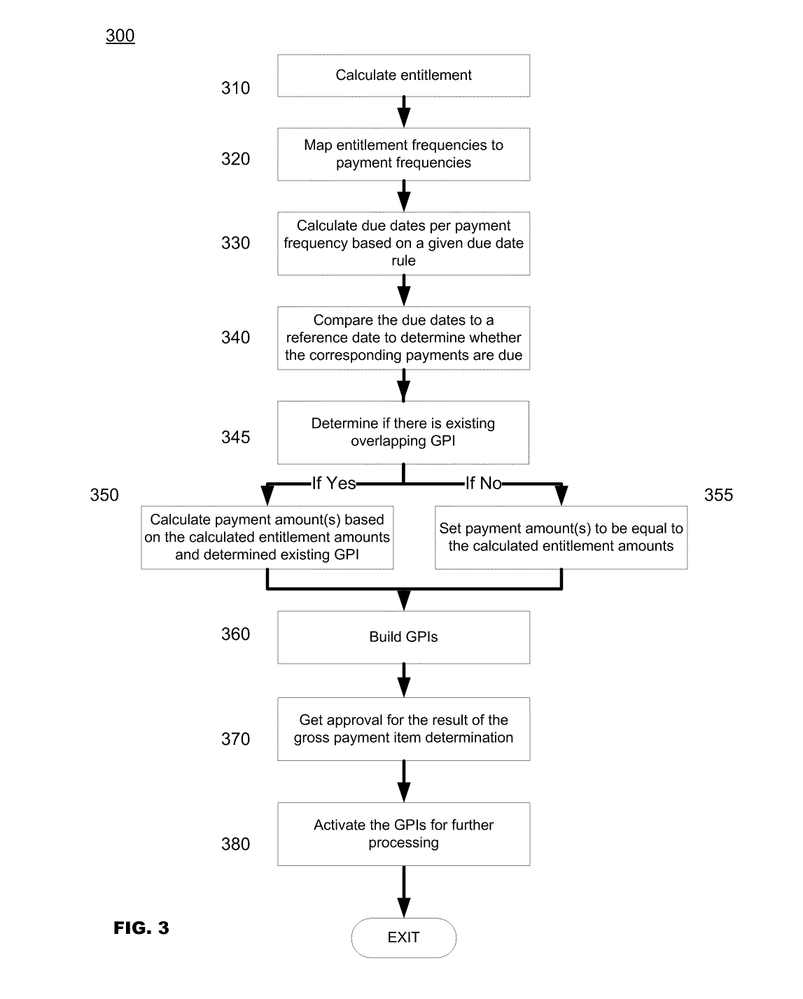

FIG. 3 illustrates an exemplary process flow 300 for gross payment item determination according to an embodiment. In at least one embodiment, the exemplary process 300 may be performed by a computer processor at a back end ERP system to provide a social services plan. At step 310, for example, the recipient's entitlement may be calculated. The calculated entitlement may be stored in entitlement document 120 as shown in FIG. 1 and described above. The calculation may be performed for an entitlement calculation period (ECR) that spans multiple entitlement periods. The ECR may be a fixed time period (e.g., three months, one year) or open-ended (e.g., as long as a senior citizen is alive). At step 320, the entitlement frequencies may be mapped to payment frequencies. For example, entitlement frequency for social services may be based on government regulations and or rules (e.g., weekly, bi-weekly, or monthly), the payment frequency may be different (e.g., several weekly entitlements may be combined to generate a monthly payment). Correspondingly, a payment period may cover one entitlement period or a plurality of entitlement periods and include fractions of entitlement periods. The entitlement frequency may be changed by the government and the payment frequency also may be adjustable (e.g., by a case administrator). As described above with respect to FIG. 2, in one embodiment, a gross payment item may be generated for one entitlement item, and thus, a gross payment period may be the same as an entitlement period and the gross payment amount may correspond to the entitlement amount for one entitlement period.

At step 330, the process flow 300 may calculate due dates for each payment frequency. The due dates may be calculated by based on a user defined due date rule (e.g., first day of the month, or every other Friday). In one embodiment, a due date rule may be specified by a modifier and a day offset. The modifier may be a relative time point (e.g., being or end) related to a provided time period (e.g., a week or a month), or a more absolute time point (e.g., the calculation date). Then at step 340, the calculated due dates may be compared to a reference date to determine whether corresponding payments are due. The reference date may also be determined by use of the due date rule and may be adjusted/set by a plan administrator. For example, the reference date may be customized to a modifier, for example, “today” or “decision of the related social service plan,” depending on the actual plan-type. Further, an offset may be applied to the modifier to determine the reference date.

At step 345, the process flow 300 may determine whether there are existing overlapping GPIs. Any existing GPIs may be stored in a data storage, such as a database. The data storage may be searched by certain criteria, for example, same payment beneficiary, same social services plan, and overlapping benefit period. The existing overlapping GPIs may be determined from existing GPIs that match the criteria. If there is no overlapping GPI, the process flow 300 may set the payment amounts to be equal to the calculated entitlement amounts at step 355. Alternatively, when it is determined that there are existing overlapping GPIs, the process flow 300 may calculate a payment amount for each entitlement period based on the entitlement amount and the existing GPIs. Then, at step 360, the process flow 300 may generate gross payment items for regular payments for all payments in the future with respect to the reference date, and under/overpayments (as one-time payments) for payments in the past with respect to the reference date. In one embodiment, the overpayment GPI may be applied as a one time deduction to a future GPI. The newly generated gross payment items may be grouped together into one gross payment document as shown in FIG. 2. The gross payment document and the gross payment items may be stored in memory and further into databases. After building the gross payment items, the process flow 300 may submit the result of the gross payment item determination for approval for at step 380. In one embodiment, the result may be submitted as a part of the related social services plan and the related social services plan may be approved as a whole. For example, the social services plan may be submitted in an email to a plan administrator. At step 390, once approved, the generated gross payment items may be activated for further processing. For example, deductions may be applied to the gross payments and checks may be prepared for the net payment amounts after deductions are applied.

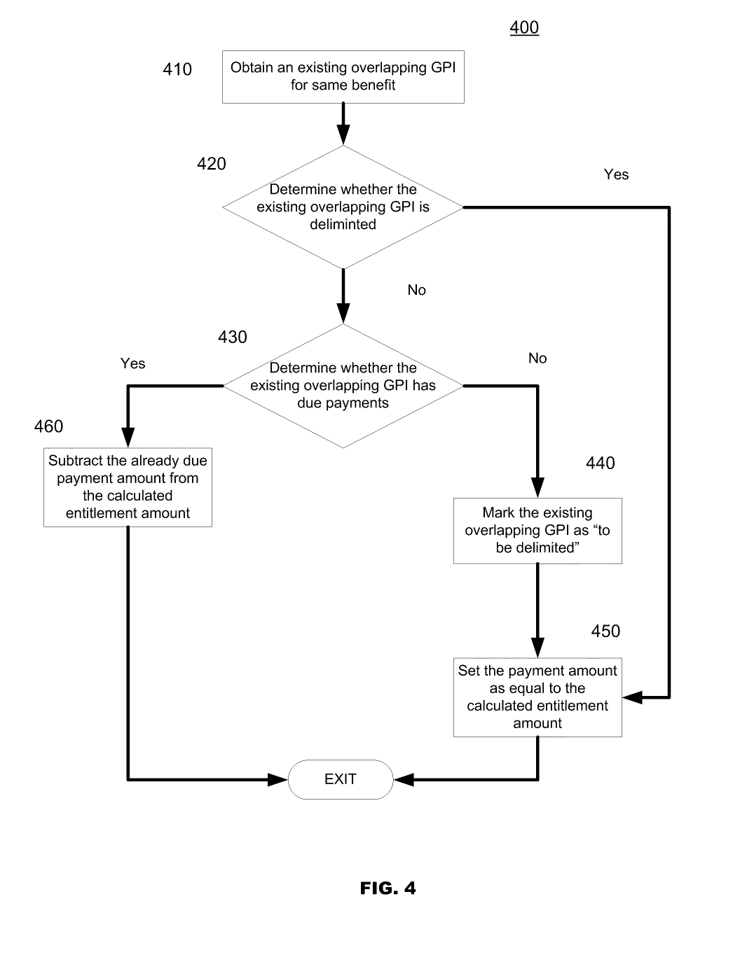

The processing of existing overlapping GPIs may affect the payment amounts in the newly generated gross payment items, and will be explained in more detail with reference to FIG. 4. In at least one embodiment, the exemplary process 400 may be performed by a computer processor at a back end ERP system. FIG. 4 illustrates an exemplary process 400 for calculating gross payment amounts with an existing overlapping gross payment item (GPI) according to an embodiment. At step 410, the exemplary process 400 may obtain an existing GPI for a gross payment item. The existing GPI may have a same benefit period for a same benefit and same beneficiary. At step 420, the exemplary process 400 may determine whether the existing overlapping GPI is delimited. For example, the existing overlapping GPI may has been determined to be obsolete and rendered as stopped from being paid. If yes, the process flow 400 may proceed to step 450, in which the payment amount may be set to be equal to the calculated entitlement amount for the entitlement period. Otherwise, if the existing overlapping GPI is not delimited, the exemplary process 400 may proceed to step 430, in which, the exemplary process 400 may determine whether the existing overlapping GPI has due payments. If it is determined that the existing overlapping GPI has a payment already due, then exemplary process 400 may proceed to step 440, in which, the existing overlapping GPI may be marked as “to be delimited.” Then, the exemplary process 400 may proceed to step 450. Otherwise, if it is determined that the existing overlapping GPI does not have a payment already due, the exemplary process 400 may proceed from step 430 to step 460, in which, the exemplary process 400 may subtract the already due payment amount from the calculated entitlement amount. After either the step 450 or 460, the exemplary process 400 may exit back to process 300 for execution of step 360.

In one embodiment, if several existing overlapping GPIs are found, the back end ERP system may loop over all existing overlapping GPIs. Steps 450 and 460 may work with intermediate results.

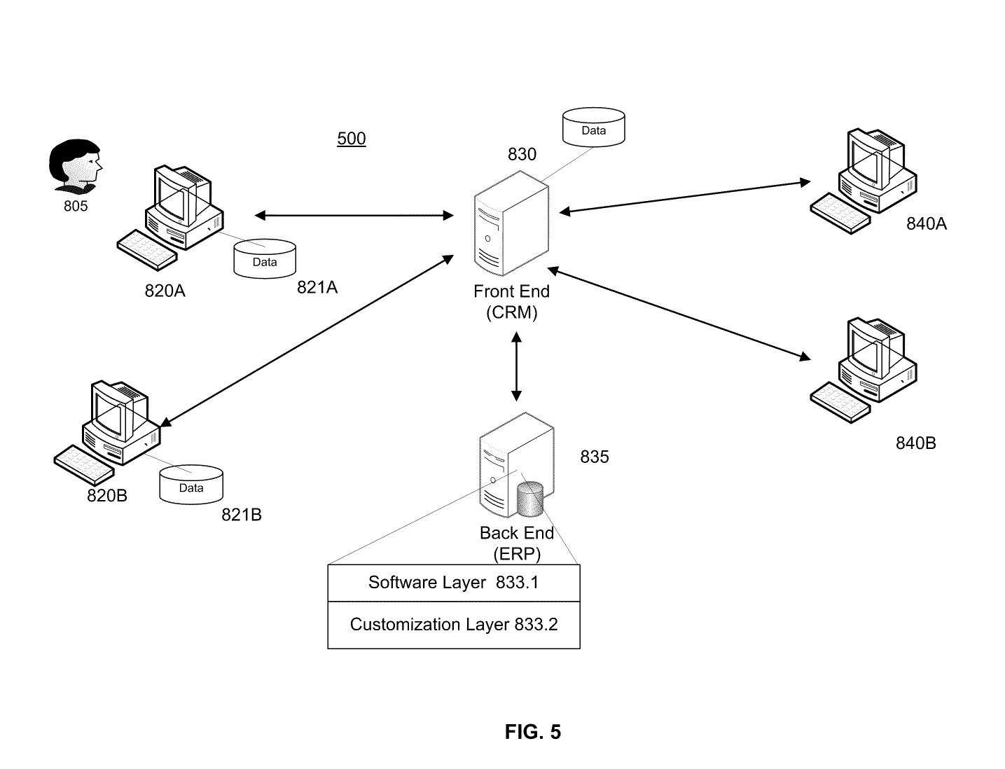

FIG. 5 illustrates an exemplary computer system for implementing a social services system. The system 500 may comprise a plurality of clients 820A and 820B, a front end server 830, a back end server 835, and a plurality of service partners 840A and 840B. Each client 820A-B may include a client computer 821A-B or, simply, be a terminal connected to the frontend server 830. A requestor/recipient 805 may provide information to the client 820A identifying the benefit(s), e.g., food stamps, meal tickets, healthcare, transportation, shelter and the like, the requestor/recipient 805 wishes to receive. According to software embodied on a storage device within any of computer 820A, a data storage 821A, or on server 830, a social service plan may be generated based on electronic forms provided to the client 820A from either computer 821A or front end server 830. However, each of clients 820A-B may be located in a different jurisdictions, such as a different country, or, if in the United States, in a different state, or county within a state, all of which may have different eligibility requirements for obtaining services and different approval rules for granting approval of the requested services. Therefore, the front end server 830 may provide a customized rule set retrieved from a data storage to generate the correct social services plan for the requester. Front end server 830 may execute a customer relationship management (CRM) application via the clients 820A or 820B to facilitate the requesting and approving process for the requestor/recipient 805. The front end server 830 may also communicate with a back end server 835 that may also, or instead of front end server 830, maintain the customized rule sets applicable to the different evaluations performed in the process. Of course, the customized rule sets may be distributed between the front end server 830 and the back end server 835.

The front end server 830 or the back end server 835 may include a software layer 833.1 that implements a social services computer application and a customization layer 833.2 that implements customized rule sets for each jurisdiction. An exemplary software architecture of the software layer 833.1 include a basic application framework that facilitates the creation of a social services plan and computer executable instructions for generation of the explained entitlement item documents, the payment item documents and calculation of the net payments due to the recipient. At various stages of the application process, the software layer 833.1 may make calls to the customization layer 833.2. The customization layer 833.2 may be generated according to local rules that affect the application process. The instructions in the software layer 833.1 may cause a processor to implement functions stored within the customization layer 833.2, such as customizable rule sets for how a recipient may be paid according to the SSP, EID and PID.

The customization layer 833.2 may be developed and maintained by the end user (e.g., a plan administrator). This allows the end user to modify any rules sets as changes occur in the criteria related to the payment of the services. In addition, as new services are provided, the end user may generate rule sets that are called by the software layer 833.1. The social services agency, or end user, that is accepting, processing according to the described exemplary methods, and/or approving the applications may use rule engines, as known in the computer science field and provided by vendors such as SAP and the like, to customize the rule sets in the customization layer 420. Alternatively to using a rules engine, the customized rule sets in customization layer 833.2 may be formulated and generated by hard coded, or developed in some other manner.

When the social services plan is completed and approved for the requestor/recipient 805, electronic documents incorporating data items may be generated to provide the details of the services that comprise the social services plan for the requestor/recipient 805. The data items within the social services plan may be used by the CRM application to generate an entitlement items document. The entitlement items document may comprise data items indicating the type of benefits to be provided, dates on which the benefits are due to be provided, and the amount of benefits the recipient is entitled.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments may be implemented in hardware, software, firmware, or a combination thereof and utilized in systems, subsystems, components or subcomponents thereof. When implemented in software, the elements of the embodiments are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer-implemented method for calculating gross payment items to provide monetary benefits to a recipient, comprising:
generating, using a computer processor of a back end of the computer system, an entitlement document for a benefit plan, the entitlement document containing data indicating the type of benefits to be provided by the benefit plan and a plurality of entitlement items, each entitlement item including an entitlement amount for an entitlement period;
mapping entitlement frequencies of the entitlement items to payment frequencies;
generating, according to mapped frequencies, a gross payment document containing a plurality of gross payment items (GPIs), each gross payment item (GPI) corresponding to an entitlement item of the entitlement document;
calculating due dates for the GPIs;
determining whether each GPI is due by comparing the calculated due dates to a reference date;
determining, for each gross payment item, whether there are existing overlapping GPIs; and
setting gross payment amounts for each GPI by taking the existing overlapping GPIs into account.

2. The method of claim 1, wherein the setting gross payment amounts for each GPI by taking the existing overlapping GPIs into account comprises:
for each GPI, searching existing GPIs for same payment beneficiary, same benefit plan, and overlapping benefit period;
for GPIs having no existing overlapping GPI, setting the gross payment amount for each GPI to the calculated entitlement amount; and
for GPIs having one or more existing overlapping GPI, determining whether the existing overlapping GPIs have been delimited;
if the existing overlapping GPIs have been delimited, setting the gross payment amount to the calculated entitlement amount; and
if the existing overlapping GPIs have not been delimited, determining whether there is due payment amounts in the existing overlapping GPIs, and if so, subtracting the due payment amounts from the entitlement amount.

3. The method of claim 2, wherein subtracting the due payment amounts from the entitlement amount including looping over all non-delimited existing overlapping GPIs and working with intermediate results accordingly.

4. The method of claim 1, wherein the due dates are calculated based on a due date rule.

5. The method of claim 4, wherein the due date rule is specified by a modifier and a day offset.

6. The method of claim 5, wherein the reference date is also determined by the due date rule.

7. The method of claim 1, wherein the generated gross payment items are submitted for approval, and once approved, are activated for further processing to calculate net payment amounts.

8. A computer system for providing and managing monetary benefits, comprising:
a plurality of client computers at a front end of the computer system; and
a back end server connected to the plurality of client computers, the server including a processor and a connection to a database, the processor configured to execute computer program instructions of:
generating an entitlement document for a benefit plan, the entitlement document containing data indicating the type of benefits to be provided by the benefit plan and a plurality of entitlement items, each entitlement item including an entitlement amount for an entitlement period;
mapping entitlement frequencies of the entitlement items to payment frequencies;
generating, according to mapped frequencies, a gross payment document containing a plurality of gross payment items (GPIs), each gross payment item (GPI) corresponding to an entitlement item of the entitlement document;
calculating due dates for the GPIs;
determining whether each GPI is due by comparing the calculated due dates to a reference date;
determining, for each gross payment item, whether there are existing overlapping GPIs; and
setting gross payment amounts for each GPI by taking the existing overlapping GPIs into account.

9. The computer system of claim 8, wherein for setting gross payment amounts for each GPI by taking the existing overlapping GPIs into account, the back end server is further configured to:
for each GPI, search existing GPIs for same payment beneficiary, same benefit plan, and overlapping benefit period;
for GPIs having no existing overlapping GPI, set the gross payment amount for each GPI to the calculated entitlement amount; and
for GPIs having one or more existing overlapping GPIs, determine whether the existing overlapping GPIs have been delimited;
if the existing overlapping GPIs have been delimited, set the gross payment amount to the calculated entitlement amount; and
if the existing overlapping GPIs have not been delimited, determine whether there is due payment amounts in the existing overlapping GPIs, and if so, subtract the due payment amounts from the entitlement amount.

10. The computer system of claim 8, wherein subtracting the due payment amounts from the entitlement amount including looping over all non-delimited existing overlapping GPIs and working with intermediate results accordingly.

11. The computer system of claim 8, wherein the due dates are calculated based on a due date rule.

12. The computer system of claim 11, wherein the due date rule is specified by a modifier and a day offset.

13. The computer system of claim 12, wherein the reference date is also determined by the due date rule.

14. The computer system of claim 8, wherein the generated gross payment items are submitted for approval, and once approved, are activated for further processing to calculate net payment amounts.

15. A computer-readable storage medium embodied with program instructions for causing a computer to execute a method for calculating gross payment items to provide monetary benefits to a recipient, the method comprising:
generating, using a computer processor of a back end of the computer system, an entitlement document for a benefit plan, the entitlement document containing data indicating the type of benefits to be provided by the benefit plan and a plurality of entitlement items, each entitlement item including an entitlement amount for an entitlement period;
mapping entitlement frequencies of the entitlement items to payment frequencies;
generating, according to mapped frequencies, a gross payment document containing a plurality of gross payment items (GPIs), each gross payment item (GPI) corresponding to an entitlement item of the entitlement document;
calculating due dates for the GPIs;
determining whether each GPI is due by comparing the calculated due dates to a reference date;
determining, for each gross payment item, whether there are existing overlapping GPIs; and
setting gross payment amounts for each GPI by taking the existing overlapping GPIs into account.

16. The computer-readable storage medium of claim 13, wherein the setting gross payment amounts for each GPI by taking the existing overlapping GPIs into account comprises:
for each GPI, searching existing GPIs for same payment beneficiary, same benefit plan, and overlapping benefit period;
for GPIs having no existing overlapping GPI, setting the gross payment amount for each GPI to the calculated entitlement amount; and
for GPIs having one or more existing overlapping GPI, determining whether the existing overlapping GPIs have been delimited;
if the existing overlapping GPIs have been delimited, setting the gross payment amount to the calculated entitlement amount; and
if the existing overlapping GPIs have not been delimited, determining whether there is due payment amounts in the existing overlapping GPIs, and if so, subtracting the due payment amounts from the entitlement amount.

17. The computer-readable storage medium of claim 16, wherein subtracting the due payment amounts from the entitlement amount including looping over all non-delimited existing overlapping GPIs and work with intermediate result accordingly.

18. The computer-readable storage medium of claim 15, wherein the due dates are calculated based on a due date rule.

19. The computer-readable storage medium of claim 18, wherein the due date rule is specified by a modifier and a day offset.

20. The computer-readable storage medium of claim 19, wherein the reference date is also determined by the due date rule.

21. The computer-readable storage medium of claim 15, wherein the generated gross payment items are submitted for approval, and once approved, are activated for further processing to calculate net payment amounts.
